(19) United States
(12) Patent Application Publication
(10) Pub. No.: US 2015/0279373 A1
(43) Pub. Date: Oct. 1, 2015

(54) VOICE RESPONSE APPARATUS, METHOD FOR VOICE PROCESSING, AND RECORDING MEDIUM HAVING PROGRAM STORED THEREON

(71) Applicant: NEC Corporation, Tokyo (JP)

(72) Inventors: Ken HANAZAWA, Tokyo (JP); Reishi Kondo, Tokyo (JP)

(73) Assignee: NEC Corporation

(21) Appl. No.: 14/672,625

(22) Filed: Mar. 30, 2015

(30) Foreign Application Priority Data
Mar. 31, 2014 (JP) 2014-070717
Mar. 31, 2014 (JP) 2014-070718

(51) Int. Cl. G10L 17/22

(52) U.S. Cl. CPC G10L 17/22

(57) ABSTRACT

A voice response apparatus, method and non-transitory computer-readable storage medium are disclosed. The voice response apparatus may include a memory storing instructions, and one or more processors configured to process the instructions to detect an input voice from an input signal using a first frequency bandwidth, output a response voice including predetermined amount of components of a second frequency bandwidth, and set the first frequency bandwidth so that the first frequency bandwidth and the second frequency bandwidth do not overlap each other.

### CROSS-REFERENCE TO RELATED PATENT APPLICATION

This application is based upon and claims the benefit of priority from Japanese Patent Application No. 2014-070717, filed on Mar. 31, 2014, and Japanese Patent Application No. 2014-070718, filed on Mar. 31, 2014. The entire disclosure of both these application is incorporated herein by reference.

### BACKGROUND

1. Technical Field

The present disclosure generally relates to a voice response apparatus, a method for voice processing, and a recording medium having a program stored thereon.

2. Description of the Related Art

Voice response and voice interaction technologies may include a barge-in function, which allows voice input to interrupt a response signal or a response voice output by a voice interaction system. For example, the barge-in function may be used in a case where a user restates his original question or response due to an error in his speech or in voice recognition. The barge-in function may also be used in a case where or the user immediately performs the next input without waiting for a response, or changes his mind and retries. This, however, may pose the problem of degradation in performance of voice detection and voice recognition as a result of the response signal being mixed with the input from a voice input microphone.

A related approach that addresses the above problem focuses on frequency characteristics of the response signal. Specifically, the conventional approach assigns a smaller weight to a frequency bandwidth for voice detection in which the amount of the response signal is large. By assigning a smaller weight to a bandwidth containing a greater portion of the response signal, the related method may identify whether an input is a voice or non-voice. Thus, the related method can prevent degradation in performance of, for example, voice detection, if the frequency bandwidths of the response signal and of the input voice do not overlap much with each other.

However, when both the response signal and the input voice have frequency bandwidths that overlap, the related approach may have the problem of degradation in performance of, for example, voice detection.

### SUMMARY OF THE DISCLOSURE

Exemplary embodiments of the present disclosure may solve one or more of the above-noted problems. For example, the exemplary embodiments may provide a voice response technique for enabling accurate voice detection during output of a response signal.

According to a first aspect of the present disclosure, a voice response apparatus is disclosed. The voice response apparatus may include a memory storing instructions; and one or more processors configured to process the instructions to output a response voice, determine a second frequency bandwidth corresponding to the response voice, select a first frequency bandwidth that does not overlap with the second frequency bandwidth, and detect an input voice from an input signal using the first frequency bandwidth.

According to a second aspect of the present disclosure, a voice response apparatus is disclosed. The voice response apparatus may include a memory storing instructions; and one or more processors configured to process the instructions to store a plurality of response voices in the memory. The one or more processors may be further configured to detect a first frequency bandwidth of an input voice from an input signal, and select a second frequency bandwidth based on the first frequency. The one or more processors may be further configured to select, from among the plurality of response voices, a response voice containing a predetermined amount of components in the second frequency bandwidth, and output the selected response voice.

A voice processing method according to another aspect of the present disclosure may include outputting a response voice, determining a second frequency bandwidth corresponding to the response voice, selecting a first frequency bandwidth that does not overlap with the second frequency bandwidth, and detecting an input voice from an input signal using the first frequency bandwidth.

A voice processing method according to another aspect of the present disclosure may include storing a plurality of response voices in the memory, detecting a first frequency bandwidth of an input voice from an input signal, and selecting a second frequency bandwidth based on the first frequency. The voice processing method may further include selecting, from among the plurality of response voices, a response voice containing a predetermined amount of components in the second frequency bandwidth, and outputting the selected response voice.

A non-transitory computer-readable storage medium may store instructions that when executed by a computer enable the computer to implement a method. The method may include outputting a response voice, determining a second frequency bandwidth corresponding to the response voice, selecting a first frequency bandwidth that does not overlap with the second frequency bandwidth, and detecting an input voice from an input signal using the first frequency bandwidth.

A non-transitory computer-readable storage medium may store instructions that when executed by a computer enable the computer to implement a method. The method may include storing a plurality of response voices in the memory, detecting a first frequency bandwidth of an input voice from an input signal, and selecting a second frequency bandwidth based on the first frequency. The method may further include selecting, from among the plurality of response voices, a response voice containing a predetermined amount of components in the second frequency bandwidth, and outputting the selected response voice.

### BRIEF DESCRIPTION OF THE DRAWINGS

FIG. 1 is a hardware configuration of a voice processing system;

FIG. 2 is an exemplary configuration of a voice response apparatus;

FIG. 3 is a flowchart depicting an exemplary method for voice processing;

FIG. 4 illustrates an exemplary configuration of a voice processing system;

FIG. 5 is a conceptual diagram illustrating an exemplary method for setting bandwidth information;

FIG. 6 is a flowchart depicting an exemplary method for voice processing;

FIG. 7 illustrates an exemplary configuration of a voice processing system;

FIG. 8 is a flowchart depicting an exemplary method for voice processing;

FIG. 9 illustrates an exemplary configuration of a voice processing system;

FIG. 10 a conceptual diagram illustrating an exemplary method for selecting a response voice;

FIG. 11 is a flowchart depicting an exemplary method for voice processing;

FIG. 12 is an exemplary configuration of a voice processing system;

FIG. 13 is a flowchart depicting an exemplary method for voice processing;

FIG. 14 illustrates an exemplary configuration of a voice response apparatus;

FIG. 15 is a flowchart depicting an exemplary method for voice processing;

FIG. 16 illustrates an exemplary configuration of a voice response apparatus; and

FIG. 17 is a flowchart depicting an exemplary method for voice processing.

### DETAILED DESCRIPTION

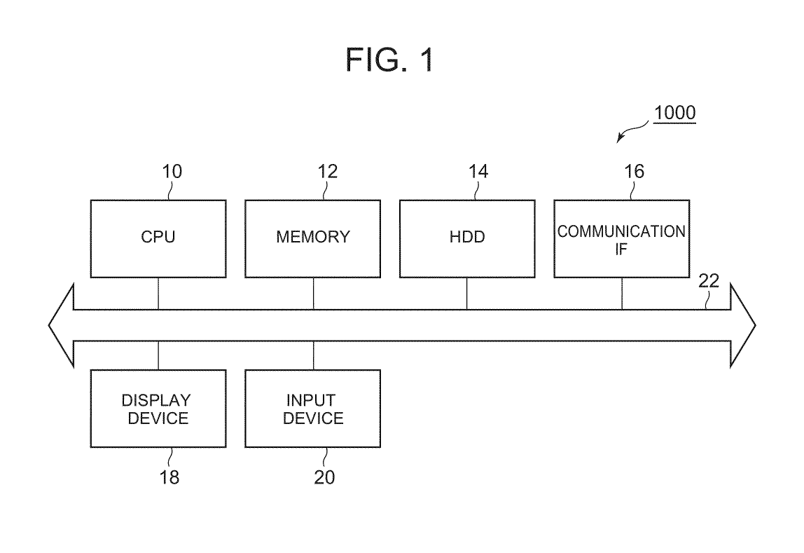

FIG. 1 is an exemplary hardware configuration diagram of a voice processing system 1000 that may implement various embodiments of the present disclosure. As illustrated in FIG. 1, voice processing system 1000 may include a CPU 10, a memory 12, a hard disk drive (HDD) 14, a communication interface (IF) 16 for data communication over a network, a display device 18 such as a display, and an input device 20 including a keyboard and a pointing device such as a mouse. These components may be interconnected via a bus 22. The hardware configuration of voice processing system 1000 may not be limited to the illustrated configuration but may be modified as appropriate. While voice processing system 1000 is illustrated as being embodied by a single computer system, it will be understood that voice processing system 1000 may be embodied as multiple computer systems.

### First Exemplary Embodiment

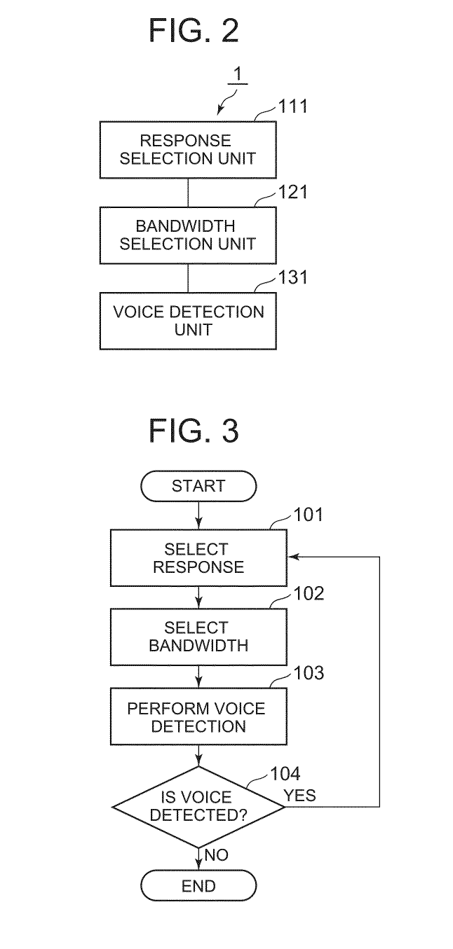

FIG. 2 illustrates an exemplary configuration of a voice response apparatus 1 implemented by CPU 10 according to a first exemplary embodiment.

As illustrated in FIG. 2, voice response apparatus 1 of may include a response selection unit 111, a bandwidth selection unit 121, and a voice detection unit 131.

Response selection unit 111 may select a response voice whose frequency bandwidth is known in advance, and may notify bandwidth selection unit 121 of the selected response voice. A response voice may refer to a voice that is output by voice processing system 1000. For example, a response voice may be a voice whose content represents a response to the content of a user's input voice.

Bandwidth selection unit 121 may select a frequency bandwidth excluding one or more frequencies of the response voice selected by response selection unit 111, and may notify voice detection unit 131 of bandwidth information indicating the selected bandwidth. For example, bandwidth selection unit 121 may select a bandwidth excluding at least part of the frequencies of the response voice. Exemplarily, bandwidth selection unit 121 may select a bandwidth excluding frequencies having large amounts of the response voice.

Voice detection unit 131 may use the bandwidth information to perform voice detection for an input voice signal. Voice detection unit 131 may use at least part of the selected bandwidth to perform the voice detection.

An exemplary method for voice processing implemented by the first exemplary embodiment is now described in detail with reference to the flowchart of FIG. 3.

In step 101, response selection unit 111 may select a response voice whose frequency bandwidth is known in advance. Response selection unit 111 may notify the bandwidth selection unit 121 of the selected response voice. Exemplarily, bandwidth selection unit 121 may select a bandwidth that does not overlap (or excludes) at least part of the frequency bandwidth of the selected response voice.

In step 102, bandwidth selection unit 121 may notify voice detection unit 131 of bandwidth information indicating the selected bandwidth. In step 103, voice detection unit 131 may perform voice detection for the input voice in at least part of the bandwidth selected by bandwidth selection unit 121.

In step 104, voice detection unit may determine if a user input voice has been detected. If voice detection unit 131 detects a voice (“Yes” in step 104), the processing may return to step 101. If voice detection unit 131 does not detect a voice (“No” in step 104), the voice processing may terminate.

Since the voice processing system in this exemplary embodiment performs voice detection for an input signal using a bandwidth excluding the frequency bandwidth of a response voice, the voice detection for the input signal may be possible even during output of the response signal.

### Second Exemplary Embodiment

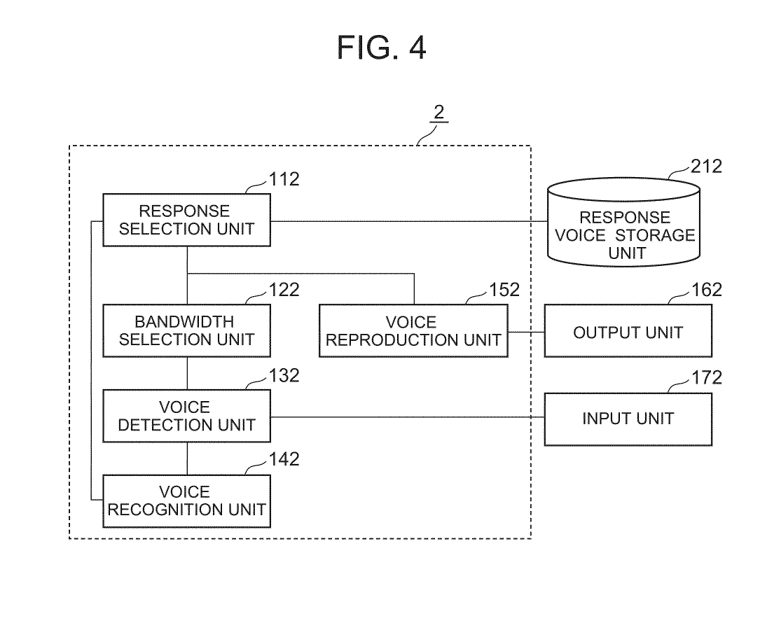

FIG. 4 illustrates an alternative configuration of voice processing system 1000 according to a second exemplary embodiment. In the second exemplary embodiment, voice response apparatus 2 may be implemented by CPU 10. Response voice storage unit 212 may be implemented by one or more of memory 12 or HDD 14. Further, voice processing system. 100 may include an output unit 162 such as a speaker, and an input unit 172 such as a microphone. The voice processing system of the second exemplary embodiment may be, for example, a voice interaction apparatus.

Voice response apparatus 2 may include a response selection unit 112, a bandwidth selection unit 122, a voice detection unit 132, a voice recognition unit 142, and a voice reproduction unit 152.

Response selection unit 112 may select a response voice from one or more response voices stored in the response voice storage unit 212, each response voice having a predetermined frequency bandwidth. Response selection unit 112 may further notify bandwidth selection unit 122 and voice reproduction unit 152 of the selected response voice.

Bandwidth selection unit 122 may select a bandwidth excluding the frequency bandwidth of the response voice selected by response selection unit 112, and may notify voice detection unit 132 of bandwidth information, which may be the selected bandwidth.

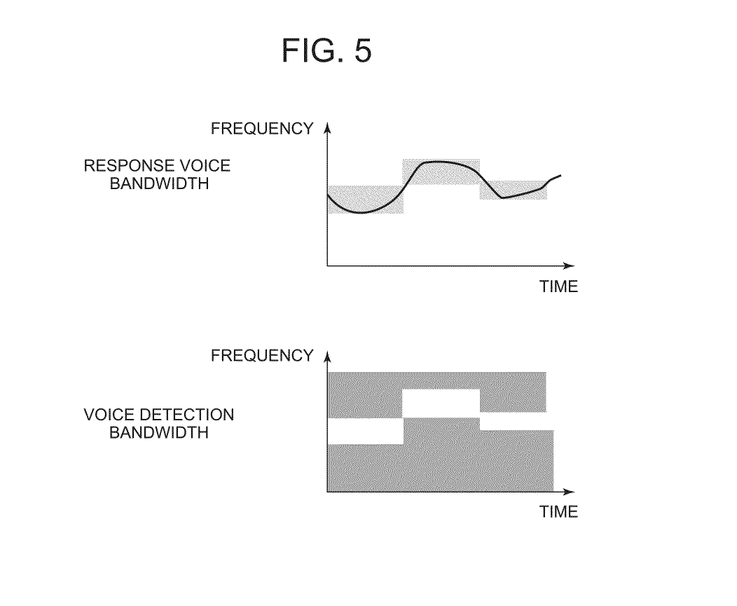

As the bandwidth information, bandwidth selection unit 122 may select a bandwidth excluding the entire bandwidth covering the response voice. In some aspects, the bandwidth of the response voice may vary over time and therefore, the selected bandwidth may vary accordingly. For example, as illustrated in FIG. 5, bandwidth selection unit 122 may extract a bandwidth covering the response voice for each unit time (e.g., for each processing frame) and set, as the bandwidth information, information indicating a bandwidth that did not cover the response voice during that unit time. In some aspects, response selection unit 112 may select the response voice so that a frequency bandwidth used immediately before is continuously used as much as possible. This may reduce the amount of overlap between the frequency bandwidths of the response voice and of the input voice when an identical user continuously performs voice input. Setting the bandwidth excluding the entire bandwidth covering the response voice as the bandwidth information may allow low-cost voice detection, whereas varying the bandwidth information every certain period of time may allow more accurate voice detection.

Bandwidth selection unit 122 may preliminarily divide the frequency bandwidth in which the voice detection is to be performed into multiple subbands, and discretely select relevant subbands. In some aspects, bandwidth selection unit 122 may weigh each subband depending on the amount of the response voice in the subband. Bandwidth selection unit 122 may assign a smaller weight to a subband in which the amount of the response voice is larger. Techniques of subband-based voice detection may be well known.

Voice detection unit 132 may receive an input voice from input unit 172 and the bandwidth information from the bandwidth selection unit 122 and perform voice detection for the input voice.

Once voice detection unit 132 detects a voice, voice detection unit 132 may notify voice reproduction unit 152 (to be described later) of the detection voice. Voice reproduction unit 152 may stop voice reproduction upon receiving the notification. In some aspects, the voice processing system of this exemplary embodiment can immediately stop the reproduction of the response voice upon successful voice detection, thereby more accurately performing subsequent processing, such as voice detection and voice recognition.

If the bandwidth information received from bandwidth selection unit 122 is weighted on a subband basis, voice detection unit 132 may vary a detection threshold according to the weight. For example, voice detection unit 132 may use the result of detection in a subband having a larger weight as a more reliable result. This may allow voice detection unit 132 to detect the voice more accurately. Voice recognition unit 142 may perform voice recognition for the voice input from input unit 172 Further, response selection unit 112 may select a response voice based on the result of the voice recognition by the voice recognition unit 142.

Voice reproduction unit 152 may cause output unit 162 to reproduce the response voice selected by the response selection unit 112.

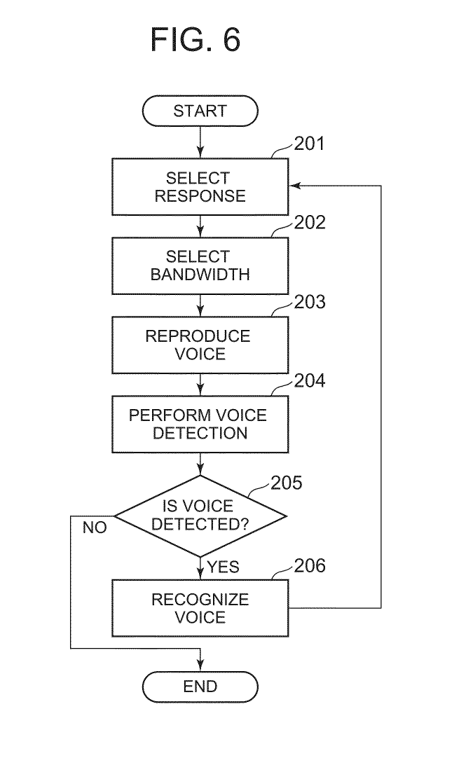

A method for voice processing according to the second exemplary embodiment will now be described in detail with reference to the flowchart of FIG. 6.

Response selection unit 112 may select, from response voice storage unit 212, a response voice whose frequency bandwidth is known in advance. In step 201, response selection unit 112 may notify voice reproduction unit 152 and bandwidth selection unit 122 of the selected response voice. For example, upon system startup, response selection unit 112 may select a response voice suitable for the start of an interaction, such as “Hello.” Bandwidth selection unit 122 may select a bandwidth excluding the frequency bandwidth of the response voice provided by the response selection unit 112. In step 202, bandwidth selection unit 122 may notify voice detection unit 132 of bandwidth information indicating the selected bandwidth. In step 203, voice reproduction unit 152 may cause output unit 162 to reproduce the response voice provided by response selection unit 112.

In step 204, voice detection unit 132 may receive an input voice from input unit 172 and bandwidth information from bandwidth selection unit 122, and perform voice detection for the input voice. If voice detection unit 132 detects a voice (“Yes” in step 205), voice recognition unit 142 may use the result of the voice detection to perform voice recognition (e.g., step 206 of FIG. 6), and the processing may return to step 201. If voice detection unit 132 does not detect a voice (“No” in step 205), the voice processing may terminate.

Since the voice processing system in this exemplary embodiment performs voice detection for an input signal in a bandwidth excluding the frequency bandwidth of a response voice, the voice detection for the input signal may be possible even during output of the response signal. In some instances, when the frequency bandwidths of the response voice and of the input voice are likely to overlap each other, the voice processing system of this exemplary embodiment may vary the bandwidth in which the voice detection is performed, depending on the temporal variations in the response voice bandwidth, thereby enabling more accurate voice detection. Further, the voice processing system of this exemplary embodiment may select the response voice so that a frequency bandwidth used immediately before is continuously used as much as possible. In some instances, the overlap between the frequency bandwidths can be more accurately avoided when an identical user continuously performs voice input.

### Third Exemplary Embodiment

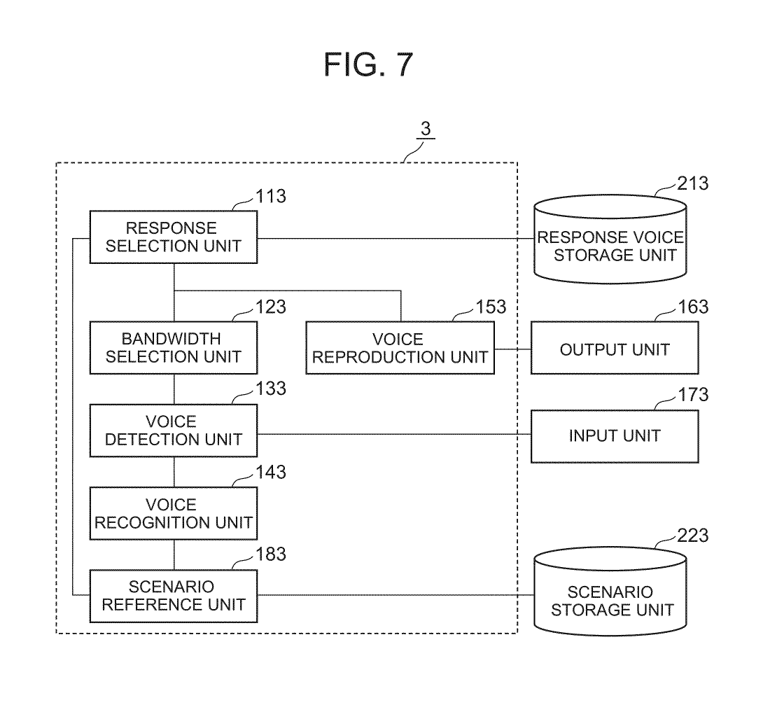

FIG. 7 illustrates an alternative configuration of voice processing system 1000 according to a third exemplary embodiment. In the third exemplary embodiment, voice response apparatus 3 may be implemented by CPU 10. Response voice storage unit 213 may be implemented by one or more of memory 12 or HDD 14. Further, voice processing system. 100 may include an output unit 163 such as a speaker, and an input unit 173 such as a microphone.

Voice response apparatus 3 may include a response selection unit 113, a bandwidth selection unit 123, a voice detection unit 133, a voice recognition unit 143, a voice reproduction unit 153, and a scenario reference unit 183.

In certain aspects, response selection unit 113, bandwidth selection unit 123, voice detection unit 133, voice reproduction unit 153, output unit 163, the input unit 173, and the response voice storage unit 213 are similar in functionality to corresponding elements of the voice processing system described above in reference to FIG. 4.

For example, and as described above, response selection unit 113 may select a response voice from one or more response voices stored in the response voice storage unit 213. Response selection unit 113 may further notify bandwidth selection unit 123 and voice reproduction unit 153 of the selected response voice. Bandwidth selection unit 123 may select a bandwidth excluding the frequency bandwidth of the response voice selected by response selection unit 113, and may notify voice detection unit 133 of bandwidth information. Voice detection unit 133 may receive an input voice from input unit 173 and bandwidth information from bandwidth selection unit 123 and perform voice detection for the input voice. Voice reproduction unit 153 may stop voice reproduction upon receiving the notification.

Voice recognition unit 143 may use the result of voice detection provided by voice detection unit 133 to recognize a voice input from input unit 173. Voice recognition unit 143 may notify scenario reference unit 183 of the result of the recognition.

Scenario reference unit 183 may refer to scenario storage unit 223 to notify the response selection unit 113 of a scenario corresponding to the result of the recognition provided by voice recognition unit 143. Scenario storage unit 223 may store scenarios representing the content of responses corresponding to results of voice recognition. The response selection unit 113 may select a response voice corresponding to the received scenario.

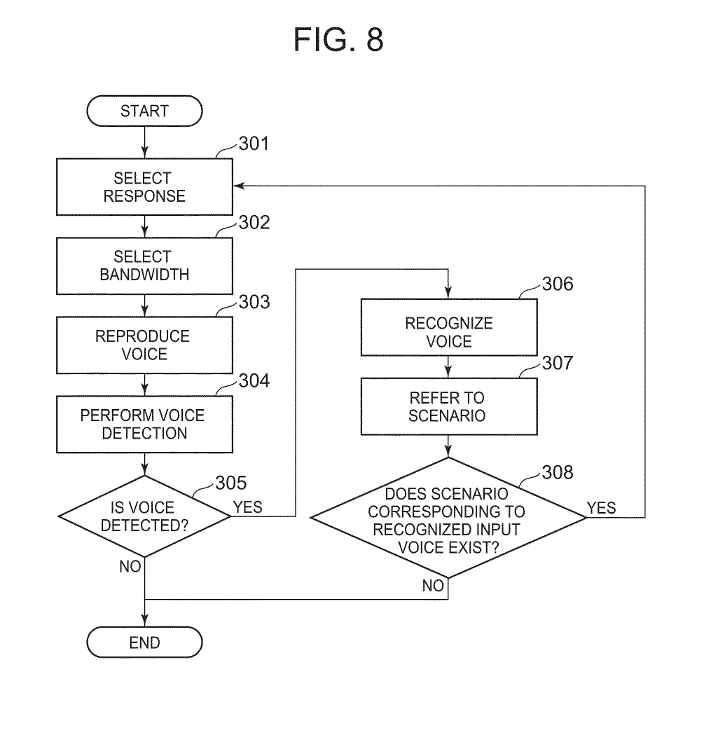

A method for voice processing of the third exemplary embodiment will be described in detail with reference to the exemplary flowchart of FIG. 8.

In step 301, response selection unit 113 may select a response voice from one or more response voices stored in response voice storage unit 213, each response voice having a frequency bandwidth known in advance. Further, response selection unit 113 may notify bandwidth selection unit 123 and voice reproduction unit 153 of the selected response voice.

In step 302, bandwidth selection unit 123 may select a bandwidth excluding the frequency bandwidth of the response voice provided by response selection unit 113. Further, bandwidth selection unit 123 may notify voice detection unit 133 of bandwidth information indicating the selected bandwidth.

In step 303, voice reproduction unit 153 may cause output unit 163 to reproduce the response voice provided by response selection unit 113.

In step 304, voice detection unit 133 may receive an input voice from input unit 173 and the bandwidth information from bandwidth selection unit 123 to perform voice detection.

If voice detection unit 133 detects a voice (“Yes” in step 305), the voice detection unit 133 may notify voice recognition unit 143 of the result of the detection. Further, voice recognition unit 143 may use the result of the voice detection to perform voice recognition (e.g., step 306 in FIG. 8). Voice recognition unit 143 may notify the scenario reference unit 183 of the result of the voice recognition. Techniques of performing voice recognition using the result of voice detection may be well known. If voice detection unit 133 does not detect a voice (“No” in step 305), the voice processing may terminate.

In step 307, scenario reference unit 183 may refer to scenario storage unit 223. If a scenario representing the content of a response corresponding to the result of the voice recognition exists in scenario storage unit 223 (“Yes” in step 308), scenario reference unit 183 may notify response selection unit 113 of that scenario, and the processing may return to step 301. In step 307, scenario reference unit 183 may refer to scenario storage unit 223. If scenario reference unit 183 does not find a scenario representing the content of a response corresponding to the result of the voice recognition (“No” in step 308), the voice processing may terminate.

### Fourth Exemplary Embodiment

### Fourth Exemplary Embodiment

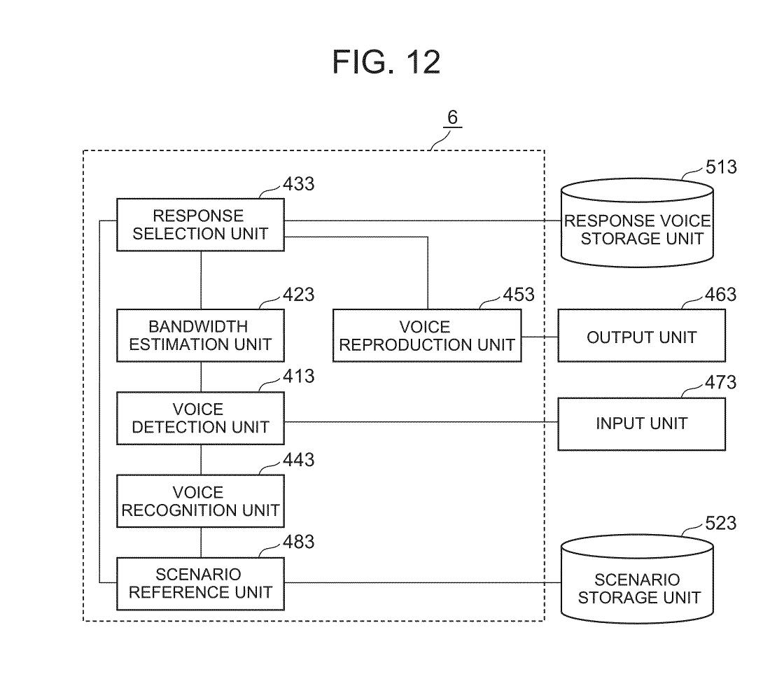

FIG. 12 is an exemplary configuration of voice processing system 1000 according to a fourth exemplary embodiment. The voice processing system in this exemplary embodiment may include a voice response apparatus 5, a response voice storage unit 512 that stores a plurality of response voices, an output unit 462 such as a speaker, and an input unit 472 such as a microphone. Voice response apparatus 5 may further include a voice detection unit 412, a bandwidth estimation unit 422, a response selection unit 432, and a voice reproduction unit 452.

Voice detection unit 412 may receive an input voice from input unit 472 and perform voice detection. If a voice is detected, voice detection unit 412 may notify bandwidth estimation unit 422 of detected bandwidth information.

Voice detection unit 412 may receive estimated bandwidth information from bandwidth estimation unit 422 and perform voice detection in a frequency bandwidth based on the estimated bandwidth information, which is discussed in detail below. By performing the voice detection in the frequency bandwidth in which the immediately preceding or past voice has been detected, more accurate voice detection may be possible when an identical user continuously performs voice input. The estimated bandwidth information resulting from the past detection may not exist at the start of the interaction. Therefore, voice detection unit 412 may, for example at the start of the voice detection, perform the voice detection in the entire frequency bandwidth.

Voice detection unit 412 may preliminarily divide the frequency bandwidth in which the voice detection is to be performed into multiple subbands (also referred to herein as “partial bandwidths”). Voice detection unit 412 may further weigh each subband depending on the amount (gain) of the detected input voice in the subband, and notify bandwidth estimation unit 422 of the detected bandwidth information such that a larger weight is assigned to a subband in which the amount of the input voice is larger than a predetermined value. Techniques of subband-based voice detection may be well known to a skilled artisan.

Bandwidth estimation unit 422 may select a bandwidth excluding at least part of the detected frequency bandwidth and notify response selection unit 432 of the selected bandwidth as the estimated bandwidth information. Bandwidth estimation unit 422 may notify voice detection unit 412 of the estimated bandwidth information. In some aspects, voice detection unit 412 may perform voice detection for the next input voice in frequencies excluding the frequencies indicated in the estimated bandwidth information. As the estimated bandwidth information, bandwidth estimation unit 422 may provide a frequency bandwidth estimated information from the result of the immediately preceding voice detection, or may provide a frequency bandwidth resulting from smoothing frequency bandwidths estimated from the results of immediately preceding voice detections.

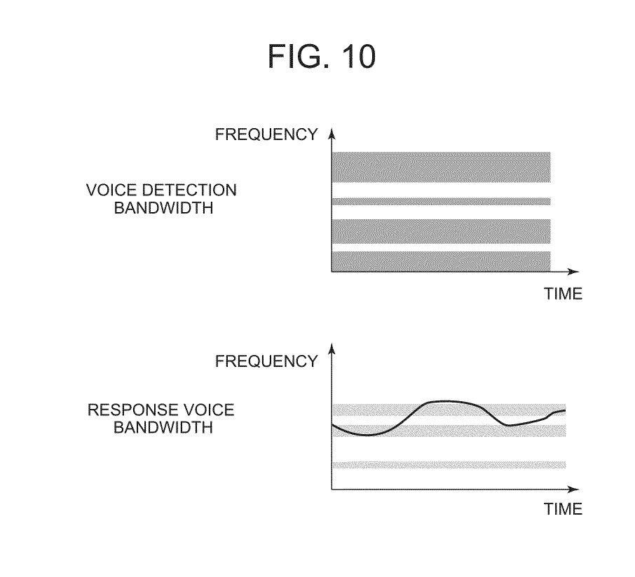

Response selection unit 432 may select, from the response voice storage unit 512, a response voice appropriate as a response and containing many components of the bandwidth indicated in the estimated bandwidth information provided by the bandwidth estimation unit 422. For example, as illustrated in FIG. 10, response selection unit 432 may select a response voice mainly containing components of the bandwidth indicated in the estimated bandwidth information (e.g., the bandwidth excluding the bandwidth used in the voice detection). Response selection unit 432 may notify voice reproduction unit 452 of the selected response voice. In certain embodiments, response selection unit 432 may select the response voice based on the result of the voice recognition by a voice recognition unit (not shown).

Further, if the estimated bandwidth information is weighted on a subband basis, response selection unit 432 may select the response voice based on the weights. As an example, assume that the bandwidth of the input voice is divided in the frequency direction into eight subbands B1 to B8, where B1 is assigned a weight of 0, B2 to B3 are assigned a large weight, B4 to B5 are assigned a small weight, B6 is assigned a large weight, and B7 to B8 are assigned a medium weight. Response selection unit 432 may select a response having fewer components in the subbands B2 to B3 and B6 and more components in the subbands B4 to B5, among the response voice candidates.

Voice reproduction unit 452 may cause output unit 462 to reproduce the response voice selected by response selection unit 432. Voice reproduction unit 452 may be notified when voice detection unit 412 starts voice detection. Voice reproduction unit 452 may stop the voice reproduction upon receiving the notification. In this manner, the reproduction of the response voice may be stopped upon the voice detection, so that voice detection unit 412 can more accurately perform subsequent voice detection.

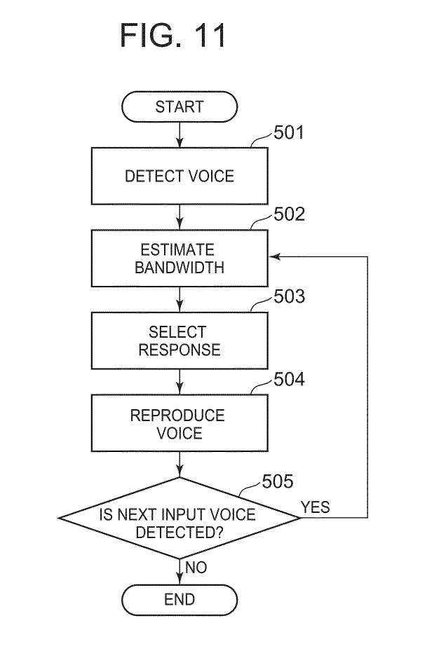

A method for voice processing of the fourth exemplary embodiment will be described in detail with reference to FIG. 11.

In step 501, voice detection unit 412 may receive an input voice and perform voice detection. Further, voice detection unit 412 may provide a notification of detected bandwidth information indicating the bandwidth covering the detected voice.

In step 502, and width estimation unit 422 may select a bandwidth excluding at least part of the bandwidth indicated in the detected bandwidth information. Further, bandwidth estimation unit 422 may notify response selection unit 432 of estimated bandwidth information indicating the selected bandwidth.

In step 503, response selection unit 432 may select, from the response voice storage unit 512, a response voice appropriate as a response and containing many components of the bandwidth indicated in the estimated bandwidth information.

In step 504, voice reproduction unit 452 may cause output unit 472 to reproduce the response voice selected by the response selection unit 432.

Voice detection unit 412 may perform voice detection for the next input voice, and if a voice is detected (“Yes” in step 505), may notify bandwidth estimation unit 422 of detected bandwidth information, and the processing may return to step 502. If voice detection unit 412 does not detect a voice (“No” in step 505), the voice processing may terminate.

The voice processing system of this exemplary embodiment can accurately detect an input voice during output of a response voice. When an identical user continuously performs voice input, the voice processing system of this exemplary embodiment may be able to perform more accurate voice detection by detecting a voice in a frequency bandwidth in which the immediately preceding or past voice has been detected.

With subband-based weighting in the voice detection, the voice processing system of this exemplary embodiment may select a response voice having a small gain or weight in bandwidth portions that have a large gain or weight for the input voice. This may allow expanding the range of variations of the response voice while preventing reduction in accuracy of the voice detection.

### Fifth Exemplary Embodiment

FIG. 12 illustrates an exemplary configuration of the voice processing system according to a fifth exemplary embodiment. The voice processing system of this exemplary embodiment is similar to the fourth embodiment except for the addition of a voice recognition unit 443, a voice reproduction unit 453, and a scenario reference unit 483.

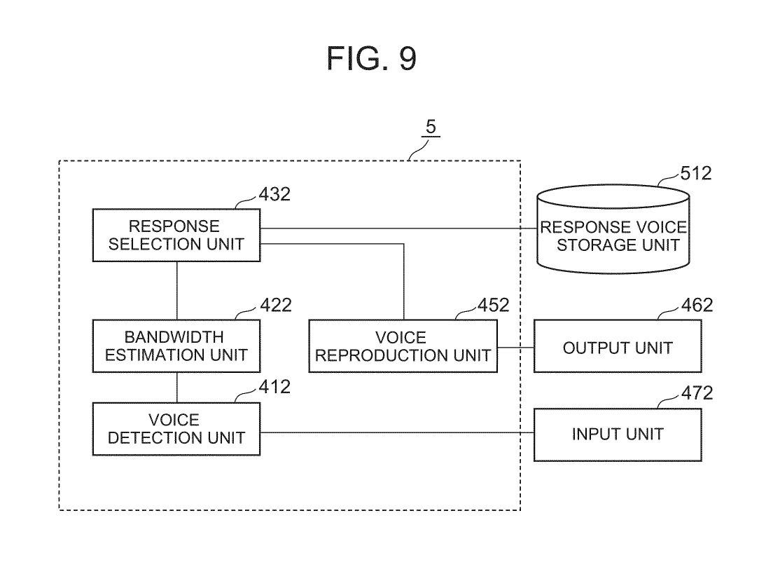

In a certain aspects, voice detection unit 413, bandwidth estimation unit 423, response selection unit 433, the voice reproduction unit 453, output unit 463, input unit 473, and response voice storage unit 513 are similar in functionality to corresponding elements of the voice processing system described above in reference to FIG. 9. Accordingly, their description is omitted.

Voice recognition unit 443 may use the result of voice detection provided by voice detection unit 413 to recognize a voice input from the input unit 473. Voice recognition unit 443 may notify scenario reference unit 483 of the result of the recognition.

Scenario reference unit 483 may refer to scenario storage unit 523 to notify response selection unit 433 of a scenario corresponding to the result of the recognition provided by t voice recognition unit 443. Response selection unit 433 may select a response voice corresponding to the received scenario. Scenario storage unit 523 may store scenarios representing the content of responses corresponding to results of voice recognition. The scenarios may be defined in a text-representation, or may be described in meta-representation which permits a degree of freedom in expression and vocabulary within the constraint that the meta-representation has the same meaning.

If the scenarios are defined in a text-representation, response voices of an identical text-representation may be voices of speakers having different voice qualities and speaking manners so that their frequency bandwidths do not overlap each other. If the scenarios are described in meta-representation, response voices having an identical meaning may take advantage of differences in expression and vocabulary in addition to differences invoice quality, so that their frequency bandwidths have still less overlap with each other. For example, expressions of asking, “ . . . shitekudasai” and “ . . . wo onegaisimasu,” may use different dominant frequency bandwidths. That is, response selection unit 433 may take advantage of the unevenness of phonemes in response voices to select a response voice containing many phonemes having a smaller amount of overlap between the frequency bandwidths. For example, phonemes of syllables beginning with the s-sound of Japanese may contain many high frequency bandwidth components. Therefore, if the input voice is assumed to contain low frequency bandwidth components, e response selection unit 433 may select a response voice with word or expression containing many phonemes of syllables beginning with the s-sound.

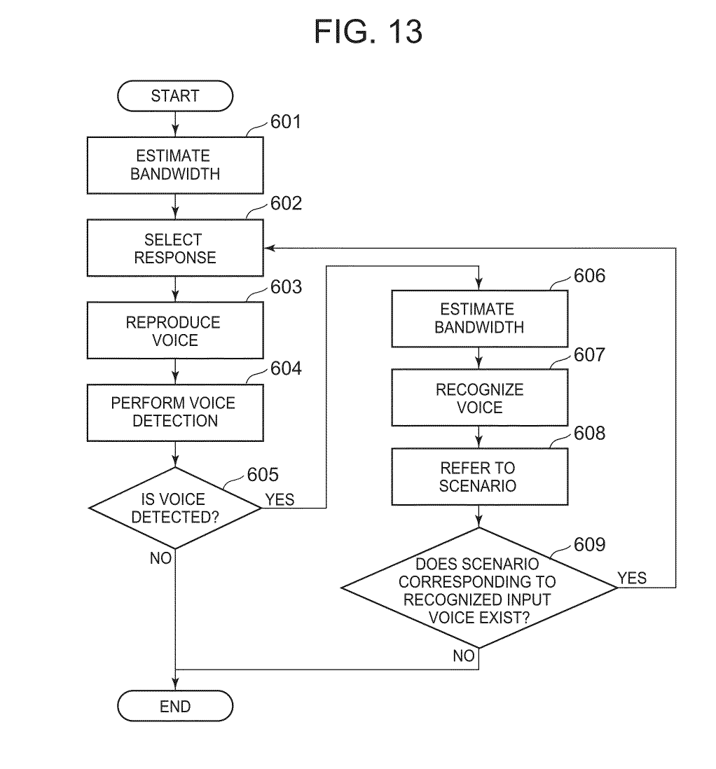

A method for voice processing of the fifth exemplary embodiment will be described in detail with reference to FIG. 13.

In step 601, bandwidth estimation unit 423 may perform a first bandwidth estimation and notify response selection unit 433 of the first estimated bandwidth information.

In step 602, response selection unit 433 may select a response voice based on the first estimated bandwidth information.

In step 603, voice reproduction unit 453 may cause output unit 463 to reproduce the response voice provided by response selection unit 433.

In step 604, voice detection unit 413 may perform voice detection for an input voice received from input unit 473.

If a voice is detected (“Yes” in step 605), voice detection unit 413 may notify voice recognition unit 443 of the result of the detection. If voice detection unit 413 does not detect a voice (“No” in step 605), the voice processing may terminate.

In step 606, bandwidth estimation unit 423 may perform a second bandwidth estimation for the detected voice and notify response selection unit 433 of estimated bandwidth information.

In step 607, voice recognition unit 443 may perform voice recognition using the result of the voice detection and notify scenario reference unit 483 of the result of the voice recognition.

In step 608, scenario reference unit 483 may refer to the scenario storage unit 523. If a scenario corresponding to the result of the recognition provided by voice recognition unit 443 exists (“Yes” in step 609), scenario reference unit 483 may notify response selection unit 433 of the corresponding scenario, and the processing may return to step 602. If a scenario corresponding to the result of the recognition provided by voice recognition unit 443 does not exist (“No” in step 609), the voice processing may terminate.

The voice processing system of this exemplary embodiment, as a voice processing system that responds based on a scenario, may accurately perform voice detection for an input signal even during output of a response signal.

### Sixth Exemplary Embodiment

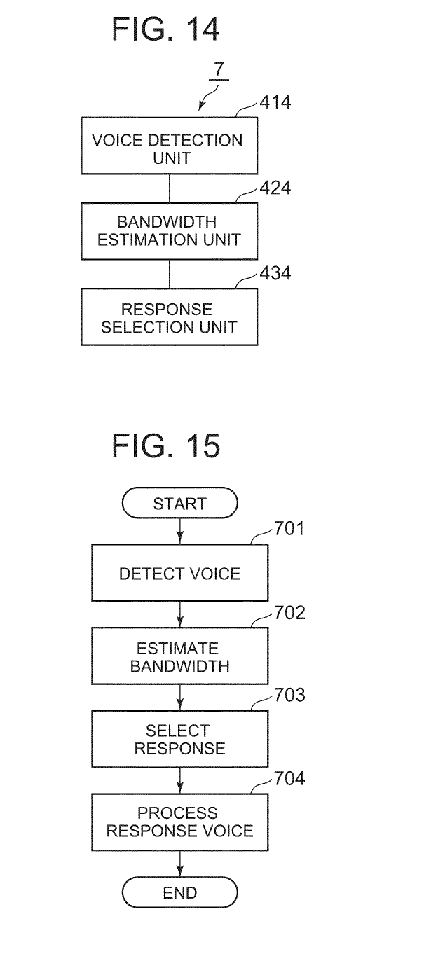

FIG. 14 is an exemplary configuration of a voice response apparatus 7 included in the voice processing system 1000 according to a sixth exemplary embodiment. Voice response apparatus 7 may be implemented by CPU 10.

As illustrated in FIG. 14, the voice response apparatus 7 may include a voice detection unit 414, a bandwidth estimation unit 424, and a response selection unit 434. Voice detection unit 414 may receive an input voice and perform voice detection. If a voice is detected, voice detection unit 414 may notify bandwidth estimation unit 424 of detected bandwidth information indicating the frequency bandwidth covering the input voice.

Bandwidth estimation unit 424 may select a bandwidth excluding at least part of the frequency bandwidth indicated in the detected bandwidth information, and notify response selection unit 434 of the selected bandwidth as estimated bandwidth information.

Response selection unit 434 may select a response voice containing many components of the bandwidth indicated in the estimated bandwidth information. A voice may contain many components of a bandwidth if the amount (gain) of the voice in that bandwidth is larger than a predetermined value. A response voice may refer to a voice that is output by the voice processing system. For example, a response voice may be a voice whose content represents a response to the content of an input voice.

Response selection unit 434 may select a response voice based on characteristics of the human voice. A male voice and a female voice may be different in their dominant frequency bandwidth components. Based on this characteristic, for example, when the input voice is assumed to be a male voice, response selection unit 434 may select a female response voice. When the input voice is assumed to be a female voice, response selection unit 434 may select a male response voice. This processing may allow avoiding the overlap between the frequency bandwidths used by the input voice and the response voice.

Response selection unit 434 may also artificially subtract, from the selected response voice, bandwidth components of the frequency bandwidth used for detecting the input voice. This processing may allow avoiding the overlap between the frequency bandwidths used by the input voice and the response voice.

For example, if the frequency bandwidth of 200 to 500 Hz and 2400 to 2800 Hz is detected for the input voice, response selection unit 434 may subtract these frequency bandwidth components from the response voice. In some aspects, if frequency bandwidth components overlapping between the input voice and the response voice are completely deleted from the response voice, the resulting response voice may sound unnatural. Therefore, response selection unit 434 may make a soft decision, for example reducing the gain, for the overlapping frequency bandwidth components, rather than completely deleting the frequency bandwidth components.

The following is an exemplary list of of rules for response selection unit 434 to identify frequency bandwidth components to be subtracted.

### (Rule 1)

A first rule may be to cut a fixed partial bandwidth in a medium bandwidth. The medium bandwidth is a bandwidth that may be known to be suitable for voice detection, and in which components of human speech certainly exist. Therefore, response selection unit 434 may process the response voice by cutting a fixed frequency range (part of the medium bandwidth) using, for example, a notch filter.

For example, as a criterion for frequencies of the medium bandwidth, the response selection unit 434 may set a bandwidth between 300 Hz and 1 kHz, in which the long-term voice spectra of many people have large values.

As another example, for an input voice of 960 Hz, setting the frequency bandwidth to be subtracted around 0.5 kHz has an undetectable influence on the voice quality of the response voice. If changing the voice quality of the response voice is permitted as in this implementation, the frequency bandwidth to be subtracted may be set around several tens to several hundreds of hertz.

### (Rule 2)

A second rule may be to cut formant valleys of a synthetic voice. Human recognition of voices is known to be sensitive to formant peaks and insensitive to formant valleys. Based on this characteristic, response selection unit 434 may cut the frequency bandwidths of formant valleys of the response voice.

For example, using a valley between a first formant peak and a second formant peak, response selection unit 434 may set the frequency bandwidth to be cut between about 200 Hz and 2000 Hz, which is suitable for detection of the input voice. Especially when the response voice is a synthetic voice, response selection unit 434 can make the voice more natural by finely measuring this frequency bandwidth as compared to a natural voice, or by processing the voice to intentionally drop this frequency bandwidth.

### (Rule 3)

A third rule may be to cut a frequency bandwidth in which the ratio between the long-term spectra of the input voice and of the response voice is large. The long-term spectrum of the input voice may vary with users. Therefore, by determining a frequency bandwidth in which the ratio between the long-term spectra of the input voice and the response voice is large, and cutting that frequency bandwidth, a point may be found at which the response voice is small and the input voice may be easily detected.

In this case, determining the frequency bandwidth based on only the ratio between the long-term spectra may lead to selecting a region where both of the input voice and the response voice have low powers. Therefore, the third rule may be applied in combination with the first and second rules.

Since the frequency bandwidth components may depend on the first phoneme in speech, e.g., human speech, the accuracy of detection of the input voice may be further increased by setting multiple frequency bandwidths corresponding to the components to be subtracted from the response voice.

An exemplary method for voice processing of the sixth exemplary embodiment will be described in detail with reference to FIG. 15.

In step 701, voice detection unit 414 may receive an input voice and perform voice detection. Voice detection unit 414 may notify bandwidth estimation unit 424 of detected bandwidth information indicating the frequency bandwidth covering the detected voice.

In step 702, bandwidth estimation unit 424 may select a bandwidth excluding at least part of the frequency bandwidth indicated in the detected bandwidth information provided by voice detection unit 414. Further, bandwidth estimation unit 424 may notify the response selection unit 434 of estimated bandwidth information indicating the selected bandwidth.

In step 703, response selection unit 434 may select a response voice containing many components of the bandwidth indicated in the estimated bandwidth information.

In step 704, the response selection unit 434 may process the selected response voice by subtracting predetermined frequency bandwidth components based on, for example, the above-described rules.

### Seventh Exemplary Embodiment

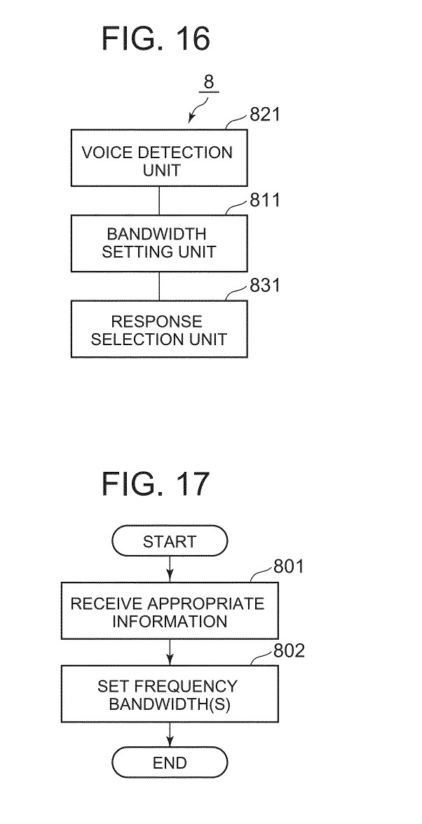

FIG. 16 is an exemplary configuration of a voice response apparatus 8 included in the voice processing system 1000 according to a seventh exemplary embodiment. Voice response apparatus 8 may be implemented by CPU 10.

As illustrated in FIG. 16, voice response apparatus 8 of the eighth exemplary embodiment may include a bandwidth setting unit 811, a voice detection unit 821, and a response selection unit 831.

Bandwidth setting unit 811 may set at least one of a first frequency bandwidth to be used by voice detection unit 821 (to be described later) for voice detection and a second frequency bandwidth to be contained in a response voice selected by response selection unit 831 (to be described later) so that the first and second frequency bandwidths do not overlap each other.

Bandwidth setting unit 811 may receive detected bandwidth information indicating the frequency bandwidth covering a detected input voice from voice detection unit 821, and set the second frequency bandwidth based on the detected bandwidth information so as not to overlap with the frequency bandwidth indicated in the detected bandwidth information. Bandwidth setting unit 811 may notify response selection unit 831 (of estimated bandwidth information indicating the set frequency bandwidth.

Once response selection unit 831 selects a response voice and notifies bandwidth setting unit 811 of the selected response voice, bandwidth setting unit 811 may set a frequency bandwidth excluding the frequency bandwidth of the response voice as the first frequency bandwidth. Bandwidth setting unit 811 may notify voice detection unit 831 of bandwidth information indicating the first frequency bandwidth.

Voice detection unit 821 may receive an input voice and perform voice detection. If a voice is detected, voice detection unit 821 may notify bandwidth setting unit 811 of detected bandwidth information indicating the frequency bandwidth covering the voice. Voice detection unit 821 may receive bandwidth information from bandwidth setting unit 811 and perform voice detection using at least part of the bandwidth indicated in the bandwidth information. Response selection unit 831 may select a response voice containing many components of the bandwidth indicated in the estimated bandwidth information.”

A method for voice processing according to the seventh exemplary embodiment will be described in detail with reference to the flowchart of FIG. 17.

In the step 801, bandwidth setting unit 811 may receive appropriate information from voice detection unit 821 or response selection unit 831.

In step 802, based on the received information, bandwidth setting unit 811 may set at least one of the first frequency bandwidth to be used by voice detection unit 821 for voice detection or second frequency bandwidth to be contained in a response voice selected by e response selection unit 831 so that the first and second frequency bandwidths do not overlap each other.

While the exemplary methods and processes may be described herein as a series of steps, it is to be understood that the order of the steps may be varied. In particular, non-dependent steps may be performed in any order, or in parallel. Also, the above-noted features and other aspects and principles of the present disclosure may be implemented in various environments. Such environments and related applications may be specially constructed for performing the various processes and operations of the disclosure or they may include a general-purpose computer or computing platform selectively activated or reconfigured by code to provide the necessary functionality. The processes disclosed herein are not inherently related to any particular computer or other apparatus, and may be implemented by a suitable combination of hardware, software, and/or firmware. For example, various general-purpose machines may be used with programs written in accordance with teachings of the disclosure, or it may be more convenient to construct a specialized apparatus or system to perform the required methods and techniques.

Systems and methods consistent with the present disclosure also include computer readable media that include program instruction or code for performing various computer-implemented operations based on the methods and processes of the disclosure. The media and program instructions may be those specially designed and constructed for the purposes of the disclosure, or they may be of the kind well known and available to those having skill in the computer software arts. Examples of program instructions include for example machine code, such as produced by a compiler, and files containing a high level code that can be executed by the computer using an interpreter.

What is claimed is:

1. A voice response apparatus comprising:
a memory storing instructions; and
one or more processors configured to process the instructions to:
output a response voice,
determine a second frequency bandwidth corresponding to the response voice,
select a first frequency bandwidth that does not overlap with the second frequency bandwidth, and
detect an input voice from an input signal using the first frequency bandwidth.

2. The voice response apparatus according to claim 1, wherein the one or more processors are further configured to process the instructions to change the first frequency bandwidth for different frames of the response voice.

3. The voice response apparatus according to claim 1, wherein the one or more processors are further configured to process the instructions to:
assign weights to subbands included in the first frequency bandwidth based on an amount of the response voice in the subbands, and
detect the input voice from the input signal based on weights of the subbands.

4. A voice response apparatus comprising:
a memory storing instructions; and
one or more processors configured to process the instructions to:
store a plurality of response voices in the memory,
detect a first frequency bandwidth of an input voice from an input signal,
select a second frequency bandwidth based on the first frequency,
select, from among the plurality of response voices, a response voice containing a predetermined amount of components in the second frequency bandwidth, and
output the selected response voice.

5. The voice response apparatus according to claim 4, wherein the second frequency bandwidth does not overlap with the first frequency bandwidth.

6. The voice response apparatus according to claim 4, wherein the one or more processors are further configured to process the instructions to:
assign a weight to a plurality of subbands in the first frequency bandwidth based on the amount of the components of the input voice included in each of the plurality of subbands, and
select the response voice based on the assigned weights.

7. The voice response apparatus according to claim 4, wherein the one or more processors are further configured to process the instructions to:
generate the response voice by subtracting at least one of components of the second frequency bandwidth from the first frequency bandwidth, and
output the generated response voice.

8. The voice response apparatus according to claim 4, wherein the one or more processors are further configured to process the instructions to:
recognize a content of the input voice based on the result of detecting the input voice,
select a scenario representing the recognized content, and
select the response voice corresponding to the selected scenario.

9. The voice response apparatus according to claim 1, wherein the one or more processors are further configured to process the instructions to select the response voice based on a frequency bandwidth included in a previously output response voice.

10. The voice response apparatus according to claim 1, wherein the one or more processors are further configured to process the instructions to stop outputting once the input voice is detected.

11. A voice response method comprising:
outputting a response voice;
determining a second frequency bandwidth corresponding to the response voice;
selecting a first frequency bandwidth that does not overlap with the second frequency bandwidth; and
detecting an input voice from an input signal using the first frequency bandwidth.

12. A voice response method comprising:
storing a plurality of response voices in the memory;
detecting a first frequency bandwidth of an input voice from an input signal;
selecting a second frequency bandwidth based on the first frequency;
selecting, from among the plurality of response voices, a response voice containing a predetermined amount of components in the second frequency bandwidth; and
outputting the selected response voice.

13. A non-transitory computer-readable medium comprising instructions to cause one or more processors to:
output a response voice;
determine a second frequency bandwidth corresponding to the response voice;
select a first frequency bandwidth that does not overlap with the second frequency bandwidth; and
detect an input voice from an input signal using the first frequency bandwidth.

14. A non-transitory computer-readable medium comprising instructions to cause one or more processors to:
store a plurality of response voices in the memory;
detect a first frequency bandwidth of an input voice from an input signal;
select a second frequency bandwidth based on the first frequency;
select, from among the plurality of response voices, a response voice containing a predetermined amount of components in the second frequency bandwidth; and
output the selected response voice.
